(19) United States
(12) Patent Application Publication
(10) Pub. No.: US 2011/0218859 A1
(43) Pub. Date: Sep. 8, 2011

(54) Method, Apparatus and System for Increasing Website Data Transfer Speed

(75) Inventors: Yongqiang Wang, Hangzhou (CN); Lei Jiang, Hangzhou (CN); Maosen Zhang, Hangzhou (CN); Bin Wan, Hangzhou (CN)

(73) Assignee: ALIBABA GROUP HOLDING LIMITED, Grand Cayman (unknown)

(21) Appl. No.: 12/937,578

(22) PCT Filed: Sep. 2, 2010
(86) PCT No.: PCT/US10/47646

§ 371 Date: Oct. 13, 2010

(30) Foreign Application Priority Data
Sep. 29, 2009 (CN) 200910178450.9

(51) Int. Cl. G06Q 30/00

(52) U.S. Cl. 705/14.53

(57) ABSTRACT

In one aspect, a method for increasing website data transmission speed comprises: obtaining a characteristics attribute set corresponding to a browsing behavior of a user; obtaining at least one rule corresponding to the characteristics attribute set from a rules database; selecting at least one advertisement corresponding to a scenario stipulated by the at least one rule; placing the at least one advertisement to be presented to the user; and monitoring operations of the user with respect to the placed at least one advertisement. Thus, the update and revolution of the rules database are implemented based on advertisement placement effects in real time. as Advantages achieved include low implementation cost, short period, and quick optimization speed. The present disclosure also discloses an advertisement placement administration apparatus and an advertisement placement administration system.

### CROSS REFERENCE TO RELATED PATENT APPLICATIONS

This application is a national stage application of an international patent application PCT/US10/047,646, filed Sep. 2, 2010, which claims priority from Chinese Patent Application No. 200910178450.9, filed on Sep. 29, 2009, entitled “A METHOD, APPARATUS AND SYSTEM FOR INCREASING WEBSITE DATA TRANSFER SPEED,” which applications are hereby incorporated in their entirety by reference.

### TECHNICAL FIELD

The present disclosure relates to network technology, and particularly relates to a method for increasing website data transfer speed.

### BACKGROUND

With the rapid enrichment of various internet services, data volumes transferred between servers and clients are also rapidly increasing. Such transferred data generally include various graphical and textual data, voice data, and video data. When a large volume of website data is transferred to the clients at the same time, sharply decreasing network data transfer speed may result, and collapse of the whole website can occur. As an example of internet advertisements, internet advertisements can quickly relay merchant information to user groups and inspire users' desire to purchase. Thus when a user browses a website, a server of the website usually sends some internet advertisement data to a client terminal such as a computer, hereinafter interchangeably referred to as “client”, of a user. If there are many users who browse the website at the same time, the server of the website will transmit large volumes of advertisement data to the client terminals of those users at the same time, thereby causing slow speed of internet data transmission and even collapse of the server of the website To reduce such negative impacts caused by transmission of internet advertisement data to a large number of clients, the current technologies often reduce the volume of advertisement data transferred to the clients of the users in order to increase the speed of internet data transmission. Blindly reducing the volume of advertisement data transferred to the clients, however, undoubtedly reduces effects of advertising. There is, therefore, an urgent need to provide a solution to increase the advertisement data transferred over the internet for guaranteed effects of advertising.

### SUMMARY OF THE DISCLOSURE

The present disclosure provides a method, apparatus and system for increasing website data transmission speed to reduce a volume of data transmission for advertising based on a guaranteed effect of advertising.

The techniques provided by the present disclosure are summarized below.

In one aspect, a method for increasing website data transmission speed comprises: obtaining a characteristics attribute set corresponding to a browsing behavior of a user; obtaining at least one rule corresponding to the characteristics attribute set from a rules database; selecting at least one advertisement corresponding to a scenario stipulated by the at least one rule; placing the at least one advertisement to be presented to the user; and monitoring operations of the user with respect to the placed at least one advertisement.

The method may further comprise: collecting parameters with respect to the at least one advertisement; storing the visitation information in website logs; and extracting a characteristics attribute from the website logs for the user. Additionally, the method may also comprise: converting the collected parameters to a corresponding rule to update the rules database. The collected parameters may comprise a user click rate, a browsing volume after arrival of a target webpage, a volume of registration, and a volume of bookmark.

The method may further comprise: calculating a respective similarity degree between each of a plurality of rules in the rules database and the characteristics attribute set; ranking the plurality of rules from high to low according to the calculated respective similarity degrees; and selecting a number of the ranked rules, among the ranked rules, starting from a rule with a highest similarity degree.

In another aspect, a system for increasing website data transmission speed comprises: a rules database that stores a plurality of rules to search advertisements; and an advertisement placement administration apparatus communicatively coupled to the rules database.

The advertisement placement administration apparatus may be configured to perform: obtaining a characteristics attribute set corresponding to a browsing behavior of a user; obtaining at least one rule corresponding to the characteristics attribute set from a rules database; selecting at least one advertisement corresponding to a scenario stipulated by the at least one rule; placing the at least one advertisement to be presented to the user; and monitoring operations of the user with respect to the placed at least one advertisement.

The advertisement placement administration apparatus may be further configured to perform: collecting parameters with respect to the at least one advertisement; storing the visitation information in website logs; and extracting a characteristics attribute from the website logs for the user. Additionally, the advertisement placement administration apparatus may also be configured to perform: converting the collected parameters to a corresponding rule to update the rules database.

The advertisement placement administration apparatus may be further configured to perform: calculating a respective similarity degree between each of a plurality of rules in the rules database and the characteristics attribute set; ranking the plurality of rules from high to low according to the calculated respective similarity degrees; and selecting a number of the ranked rules, among the ranked rules, starting from a rule with a highest similarity degree. The collected parameters may comprise a user click rate, a browsing volume after arrival of a target webpage, a volume of registration, and a volume of bookmark.

In yet another aspect, an apparatus for increasing website data transmission speed comprises: an obtaining unit that obtains a characteristics attribute set corresponding to a browsing behavior of a user, and, according to the characteristics attribute set, obtains at least one rule corresponding to the characteristics attribute set from a rules database; a first processing unit that selects at least one advertisement corresponding to a scenario stipulated by the at least one rule, and places the at least one advertisement to be presented to the user; and a second processing unit that monitors operations of the user with respect to the placed at least one advertisement, and converts collected parameters to a corresponding rule to update the rules database.

The technique proposed in the present disclosure introduces the concept of the rules database to accumulate successful advertising experiences. For various effects brought by advertising, the proposed technique categorizes various factors associated with the advertising, and obtains statistics for one or more rules with better effects of advertising in each category. The proposed technique summarizes better-matching rules for advertising in each category. The establishment and evolution of the rules database directly depend on the effects of advertising. A change in the effects of advertising will be timely reflected in the stored various rules to guide selection of advertisements through the rules database so that a selection of the advertisements will be totally dependent on the effects of advertising. An update of the rules database will be implemented in real time based on the effects of advertising. Thus, an optimization of the various rules is automatic and real-time, and has advantages such as low cost for implementation, short period, and rapid optimization speed. There is no need to blindly reduce the volume of advertisements and, rather, corresponding advertisements will be transmitted based on actual needs of the users. The proposed technique reduces unnecessary volume of advertisements and, based on guaranteed effects of advertising, reduces data transmitted for advertising, increases data transmission speed of the system, and improves the service quality of the website.

### DESCRIPTION OF DRAWINGS

FIG. 1 illustrates an exemplary structural diagram of advertisement placement in accordance with the present disclosure.

FIG. 2 illustrates an exemplary diagram of functions of advertisement placement in accordance with the present disclosure.

FIG. 3 illustrates an exemplary flowchart of administration of advertisement placement based on effects of advertising in accordance with the present disclosure.

### DETAILED DESCRIPTION

One embodiment of the present disclosure uses a rules database based on effects of advertising to support a selection of advertisement placement strategy in order to increase a transmission speed of website data. Details are described below. An apparatus for administration of advertise placement obtains a corresponding characteristics attribute set according to operations of a user's browsing behavior. As an example of a scenario that a user browses web pages, the characteristics attribute set may include a browsing time, a browsed webpage ID, an advertisement location ID, a user identification ID, etc. According to the characteristics attribute set, the apparatus obtains at least one corresponding rule matching, or otherwise corresponding to, the characteristics attribute set from a preset rules database, selects at least one advertisement corresponding to a scenario stipulated by the obtained at least one rule, and places the at least one advertisement for presentation to the user. In addition, the apparatus also monitors operations of the user arising from the placed at least one advertisement, and converts collected relevant parameters to a corresponding rule to update the preset rules database.

The characteristics attribute set is used to describe specificity of the user's browsing time, a characteristic of browsed webpage and advertisement, long-term interest preference of the user, a latest intention preference of operational behavior when the user browses a website, and so on. Thus there is no need to blindly reduce advertisement placements. Rather, the apparatus can purposefully place corresponding advertisements according to actual needs of the user by reducing unnecessary advertisement placements. Thus, based on a guaranteed effect of advertisement placement, the apparatus reduces transmitted data volume when placing advertisements, increases data transmission speed of a system, thereby improving service quality of the website.

The advertisement effect refers to an index evaluating a popularity of the advertisement to the user after placement of the advertisement, including a plurality of preset parameters, such as a user click rate, a browsing volume after arrival of a target webpage, a volume of registration, a volume of bookmark, a volume of purchase, and some other factors.

The rules database refers to a set of placement matching rules that have better placement results in each category of advertisement, concluded from prior advertisement effects after placement of the advertisement, from categorization of a plurality of factors relating to placement, and from statistics of placements with better advertisement effect in each category. The rules database needs to be updated in real-time to accumulate evolving experiences and uses such accumulated experiences to guide future advertisement placement.

One or more preferred embodiments of the present disclosure are described in details by references to the Figures.

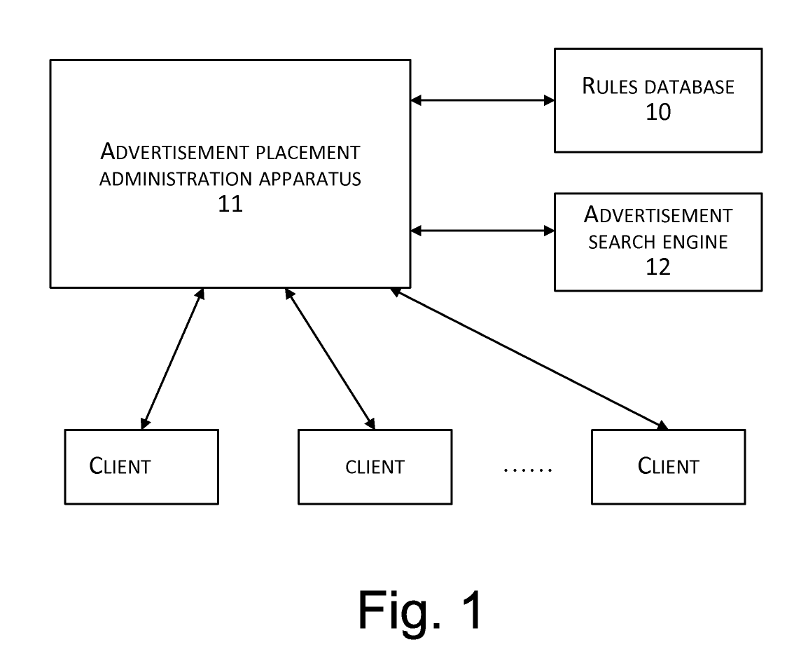

FIG. 1 illustrates a system for administration of advertisement placement to improve website data transmission speed. The system includes a rules database 10 and an advertisement placement administration apparatus 11 communicatively coupled to the rules database 10. In one embodiment, the advertisement placement administration apparatus 11 comprises one or more servers. For example, the advertisement placement administration apparatus 11 may be implemented in a processor-based server that includes one or more computer-readable storage media, such as memories, and communication means to communicate to a network and other devices and apparatuses connected to the network. In one embodiment, the rules database 10 and the advertisement placement administration apparatus 11 are implemented in separate servers. In another embodiment, the rules database 10 and the advertisement placement administration apparatus 11 are implemented in a single server.

The rules database 10 stores a plurality of rules to search advertisements, accumulates prior experiences of implementing advertisement placement strategies, and updates the stored information in real time. The accumulation of various rules in the rules database 10 includes advertisement placement strategies with better effects, thereby providing valuable experiences for future operations. The present embodiment, when implementing the advertisement placement strategies for advertisement placement, fully considers all factors affecting effects of advertisement placement, selects an advertisement placement strategy, and guarantees a global optimization of the advertisement placement strategy. For example, when selecting the advertisement placement strategy for one advertisement, the system sets up various parameters in the advertisement placement strategy, such as a placement time, a number of placements, in accordance with characteristics data such as an advertisement location, a placement scenario, a user's browsing interest and recent browsing behaviors.

The advertisement placement administration apparatus 11 obtains a corresponding characteristics attribute set according to operations of the user's browsing behavior, and, according to the characteristics attribute set, obtains at least one corresponding rule matching, or otherwise corresponding to, the characteristics attribute set from the preset rules database. The advertisement placement administration apparatus 11 further selects at least one advertisement corresponding to a scenario stipulated by the obtained at least one rule, sends the at least one advertisement to the user, monitors operations of the user arising from the sent at least one advertisement, collects relevant parameters with respect to the at least one advertisement, and converts collected relevant parameters to a corresponding rule to update the preset rules database. The relevant parameters include a plurality of preset parameters such as a user click rate, a browsing volume after arrival of a target webpage, a volume of registration, a volume of bookmark, a volume of purchase, etc.

In one embodiment, the system, when selecting the advertisement placement strategy, can search for an accepted advertisement placement strategy accepted by a historically identical or similar placement instances as reference data, rank the placement rules corresponding to effects of the placement instances from high to low according to scores of effects of the placements, and find several advertisement placement strategies with best effects and corresponding advertisement characteristics parameters. The system can also make combination variance or extended variance, within proper probabilities, to the advertisement characteristics parameters, select qualified alternative advertisements according to the varied advertisement characteristics parameters, conduct probabilities competition operation for the alternate advertisements according to comprehensive scores of the placement effects, and finally select an advertisement to be placed. The system then conducts monitoring of the placed advertisements in real time, monitors the placement effects, and finally adjusts and updates a current selected advertisement placement strategy according to the placement effect. The system accumulates good placement patterns and removes bad placement patterns to optimize the advertisement placement strategies. Thus the system reduces transmitted data volume of network advertisements and achieves good effects of advertisement placements.

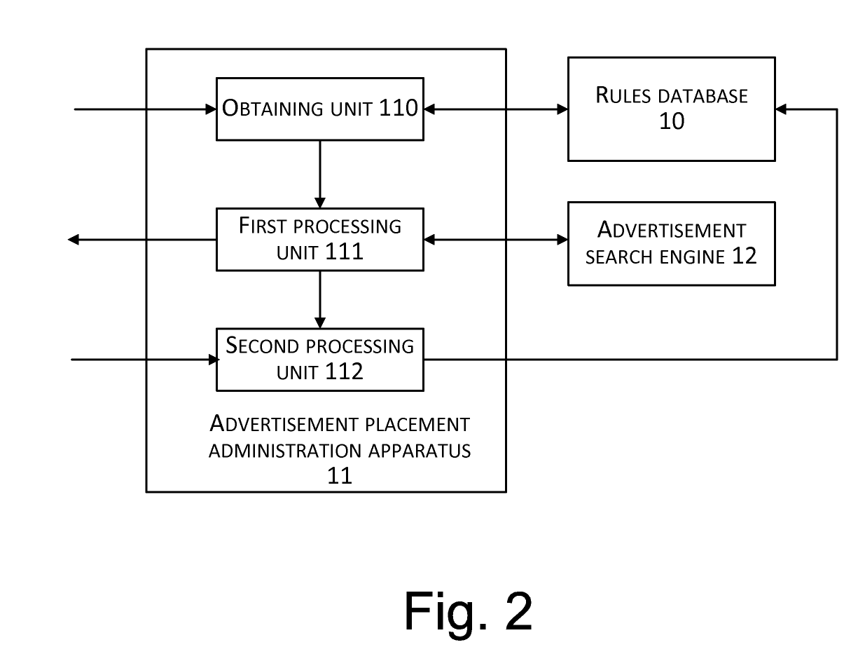

FIG. 2 illustrates the advertisement placement administration apparatus 11 including an obtaining unit 110, a first processing unit 111, and a second processing unit 112.

The obtaining unit 110 is configured to obtain a corresponding characteristics attribute set according to operations of a user's browsing behavior, and, according to the characteristics attribute set, to obtain at least one corresponding rule matching, or otherwise corresponding to, the characteristics attribute set from a preset rules database.

The first processing unit 111 is configured to select at least one advertisement corresponding to a scenario stipulated by the obtained at least one rule, and to send the at least one advertisement to the user.

The second processing unit 112 is configured to monitor operations of the user arising from the sent at least one advertisement, and to convert collected relevant parameters to a corresponding rule to update the preset rules database.

In one embodiment, a rule is comprised of several vector data in the above rules database 10 as described below.

A. A characteristic vector of advertisement position (referred to as Fₐ) includes the following vectors: a website channel corresponding to advertisement position (referred to as Fₐ¹), a category of advertisement position (referred to as Fₐ²), a category of a webpage where the advertisement locates (referred to as Fₐ³), and a keyword of the webpage where the advertisement locates (referred to as Fₐ⁴). A relationship among the above vectors can be represented as: Fₐ=(Fₐ¹,Fₐ²,Fₐ³,Fₐ⁴).

B. A characteristic vector of placement scenario of advertisement position (referred to as F_{b}) includes the following vectors: a placement time (referred to as F_{b}¹), a date type (referred to as F_{b}²), a season (referred to as F_{b}³), and an event mark (referred to as F_{b}⁴). The event mark is used to mark whether there is a remarkable matter recently. A remarkable matter includes, but is not limited to: earthquake, politics, economics, college entrance examination, etc. A relationship among the above vectors can be represented as: F_{b}=(F_{b}¹,F_{b}²,F_{b}³,F_{b}⁴).

In one embodiment of the present disclosure, the vector Fₐ is connected with F_{b} to generate a new vector F_{ab}=(Fₐ,F_{b}), referred to as an advertisement position vector. The advertisement position vector describes total placement influence factors without being dependent on the user when placing the advertisement.

C. A characteristic vector of user natural attribute and historically long-term interest behavioral (referred to as F_{c}) includes the following vectors: a user gender (referred to as F_{c}¹), a user age bracket (referred to as F_{c}²), a user interest (referred to as F_{c}³ which is a regular browsing pattern of the user depending on holidays and time brackets), a user shopping interest (referred to as F_{c}⁴, which is a list or category of items that the user regularly browses and shops), a user preferred keyword (referred to as F_{c}⁵), a user brand preference (referred to as F_{c}⁶), a user spending level (referred to as F_{c}⁷, which is a price bracket of items that the user browses and purchases), a user preference to merchandiser (referred to as F_{c}⁸), a user territory (referred to as F_{c}⁹), and a user credibility (referred to as F_{c}¹⁰). A relationship among the above vectors can be represented as F_{c}=(F_{c}¹,F_{c}², . . . , F_{c}¹⁰).

D. A characteristic vector of user's recent real-time browsing and purchasing (referred to as F_{d}) includes the following vectors: a short-term and currently clicked advertisement category (referred to as F_{d}¹), a short-term and currently browsed item category (referred to as F_{d}²), a short-term and currently purchased item category (referred to as F_{d}³), a short-term and currently clicked advertisement position category (referred to as F_{d}⁴), and a short-term and currently browsed webpage category (referred to as F_{d}⁵). A relationship among the above vectors can be represented as: F_{d}=(F_{d}¹,F_{d}², . . . , F_{d}⁵).

In one embodiment, the vector F_{c} is connected with the vector F_{d} to generate a new vector F_{cd}=(F_{c},F_{d}), referred to as a user characteristics vector, which represents a long-term and short-term characteristics attribute of the user, also referred to as a user characteristics attribute vector.

E. A characteristic vector of advertisement placement strategy of advertisement position (referred to as Fₑ) includes the following vectors: an advertisement placement strategy (referred to as Fₑ¹) and corresponding setup parameters (referred to as Fₑ²). The advertisement placement strategy is a placement method used to present the advertisement, such as a placement by a keyword-content match algorithm, a placement by a user-behavior match algorithm, or a placement by advertisement effect. The corresponding setup parameters of the advertisement placement strategy may include a user identification, an advertisement keyword, and so on. A relationship among the above vectors can be represented as: Fₑ=(Fₑ¹,Fₑ²).

F. A characteristic vector of placed advertisement (referred to as F_{f}) includes the following vectors: an advertised product type (referred to as F_{f}¹), an advertisement category (referred to as F_{f}²), an advertisement display form (referred to as F_{f}³, i.e. picture and text, textual chain, or flash), a self-defined parameter of advertisement content (referred to as F_{f}⁴, i.e., a keyword used to click for search), a keyword for pricing bidding of advertisement (referred to as F_{f}⁵), a bidding price of advertisement (referred to as F_{f}⁶), a credibility of advertisement owner (referred to as F_{f}⁷) a brand of advertised product (referred to as F_{f}⁸), a price bracket of advertised product (referred to as F_{f}⁹), an advertisement merchandiser type (referred to as F_{f}¹⁰), and an advertisement merchandiser territory (referred to as F_{f}¹¹). A relationship among the above vectors can be represented as: F_{f}=(F_{f}¹,F_{f}², . . . , F_{f}¹¹).

In one embodiment, the vectors Fₐ,F_{b},F_{c},F_{d},Fₑ,F_{f} are connected to generate a new vector F=(Fₐ,F_{b},F_{c},F_{d},Fₑ,F_{f}), which is a detailed description of the rules database that stipulates advertisement placement strategies.

G. A index vector of advertisement effect unification (referred to as F_{g}) includes the following vectors: a click-through rate (referred to as F_{g}¹), a click-through income (referred to as F_{g}²), a introduced flow (referred to as F_{g}³), a number of saved times (referred to as F_{g}⁴), a sales amount (referred to as F_{g}⁵), a commission amount (referred to as F_{g}⁶), a close rate (referred to as F_{g}⁷), and a registration rate (referred to as F_{g}⁸).

Through the vector F_{g}, a score S for description of advertisement placement effects can be calculated. A formula to calculate S is as follows:

$$S = {\sum }_{i = 1}^{8} {w}_{i} \times Norm ( {F}_{g}^{i} ) , wherein {\sum }_{i = 1}^{8} {w}_{i} = 1 ,$$

wᵢ represents a weight factor; Norm(F_{g}ⁱ)=100×(F_{g}ⁱ/ F̅_̅{̅g̅}̅ⁱ̅) is a normalized function to convert F_{g}ⁱ into a number between 0 and 100.

Thus, S is in a range between 0 and 100. The weight factor wᵢ is preset by an administrator according to experience values. In one example, the click-through rate F_{g}¹ is the most important factor in evaluating advertisement effects. It can be presupposed that w₁=1 and then

$$S = 1 \times Norm ( {F}_{g}^{1} ) + {\sum }_{i = 2}^{8} 0 \times Norm ( {F}_{g}^{i} ) = Norm ( {F}_{g}^{1} ) .$$

In another example, each vector in determining F_{g} has an equal importance, and it can be presupposed that wᵢ=⅛=0.125. In brief, the more wᵢ approaches 1, the higher weight of the vector corresponding to F_{g}ⁱ in evaluation of advertisement effects.

In one embodiment, the vectors Fₐ,F_{b},F_{c},F_{d},Fₑ,F_{f},F_{g} are connected into a new vector Fₛₜₐₜ=(Fₐ,F_{b},F_{c},F_{d},Fₑ,F_{f},F_{g}). The vector Fₛₜₐₜ is referred to as an index vector for statistics of advertisement placement effects.

Based on configuration of the above parameter, the following detailed descriptions are illustrated by reference to a specific application scenario. In this illustrative example, there are three advertisements for initial selection of placement, including an advertisement A, an advertisement B, and an advertisement C. After placing the three advertisements for a period of time and when a user logs into the website, the system needs to choose which one of the three advertisements to place for presentation to the user according to the advertising effects of the three advertisements.

In one embodiment, preset rules in the rules database and a user visitation scenario are assumed as follows:
Three advertisements A, B, C;
The advertisement A for an advertised product: MP3; price of the advertised product <$1,000; credit score of the merchandiser: 200; presentation form of the advertisement: picture; an exact matching placement by selection of keyword; bidding price: $0.3.
The advertisement B for an advertised product: touch-screen cell phone; price of the advertised product >$2,000; credit score of the merchandiser: 500; presentation form of the advertisement: flash; a fuzzy matching placement by selection of keyword; bidding price: $0.8.
The advertisement C for an advertised product: doll; price of the advertised product <$100; credit score of the merchandiser: 30; presentation form of the advertisement: picture; a fuzzy matching placement by selection of keyword; a bidding price: $1.

The above advertisements are published by the administrator on a server side of the network, pre-stored at a database, and obtained by an advertisement search engine.

There are six preset rules stored in the rules database for the above three advertisements, as described below.

1. R1=(male user; interested in digital products; median-and-above income; recently purchased touch-screen cell phone; often visits advertisement positions of news category; a clicked advertisement is a MP3; a price of purchased advertised product <$2000; a time period for advertisement place is weekends; a credit score of the merchandiser who places the advertisement is higher than 20; a presentation form of the advertisement is flash; an exact matching placement by selection of keyword; $0.2<an average click-through bidding price <$0.4).

2. R2=(male user; interested in sports equipments; unknown income; recently purchased roller skates; often visits advertisement positions of blog category; a clicked advertisement is a tough-screen cell phone; a price of purchased advertised product >$2000; a time period for advertisement placement is weekends mornings; a credit score of the merchandiser who places the advertisement is higher than 3000; a presentation form of the advertisement is flash; a fuzzy matching placement by selection of keyword; $0.3<an average click-through bidding price <$1).

3. R3=(male user; interested in sports equipments; no income (students); recently purchased perfumes; often visits advertisement positions of comic and animation category; a clicked advertisement is a doll; a price of purchased advertised product <$100; a time period for advertisement placement is evenings of business days; a credit score of the merchandiser who places the advertisement is higher than 20; a presentation form of the advertisement is picture; a fuzzy matching placement by selection of keyword; $0.3<an average click-through bidding price <$1.3).

4. R4=(female user; interested in sports equipments; high income; recently purchased perfumes; often visits advertisement positions of news category; a clicked advertisement is a touch-screen cell phone; a price of purchased advertised product >$5000; a time period for advertisement placement is mornings of business days; a credit score of the merchandiser who places the advertisement is higher than 500; a presentation form of the advertisement is picture; an exact matching placement by selection of keyword; $0.3<an average click-through bidding price <$1.3).

5. R5=(female user; interested in dolls; median income; recently purchased a MP3; often visits advertisement positions of blog category; a clicked advertisement is a doll; a price of purchased advertised product <$100; a time period for advertisement placement is weekend evenings; a credit score of the merchandiser who places the advertisement is higher than 30; a presentation form of the advertisement is picture; an exact matching placement by selection of keyword; $0.5<an average click-through bidding price <$0.8).

6. R6=(female user; interested in ornaments; median and above income; recently purchased a MP3; often visits advertisement positions of comic and animation category; a clicked advertisement is a touch-screen cell phone; a price of purchased advertised product >$2000; a time period for advertisement placement is weekend mornings; a credit score of the merchandiser who places the advertisement is higher than 300; a presentation form of the advertisement is picture; a fuzzy matching placement by selection of keyword; $0.5<an average click-through bidding price <$0.8).

Based on the above rules; uses' visitation scenarios are assumed as follows:

Scenario 1: (a user U₁; at a weekend morning; often visits advertisement positions of news category)

Scenario 2: (a user U₂; at a business day evening; often visits advertisement positions of blog category)

Scenario 3: (a user U₃; at a business day morning; often visits advertisement positions of news category)

According to the above three scenarios, the advertisement placement administration apparatus 11 collects visitation information of users, stores the visitation information in website logs, and extracts a characteristics attribute for each user after analyzing the website logs.

The characteristics attributes of the three users can be obtained, which are described below.

The characteristics attribute of the user U₁ is (male; interested in digital products; median and above income; recently purchased a touch-screen cell phone).

The characteristics attribute of the user U₂ is (female; interested in doll products; median income; recently purchased a MP3).

The characteristics attribute of the user U₃ is (female; interested in sports equipments; high income; recently purchased a touch-screen cell phone).

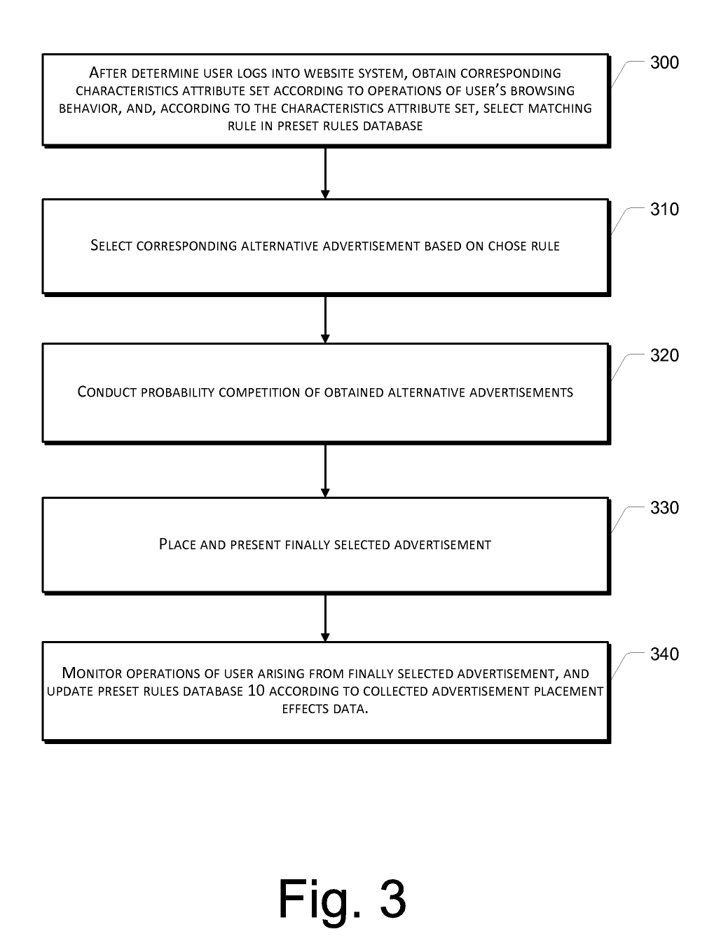

FIG. 3 illustrates a process that the advertisement placement administration apparatus 11, based on advertisement effects, manages advertisement placements. In other words, the process and its various embodiments described below can be executed on or by the advertisement placement administration apparatus 11, which may be implemented on one or more servers.

Action 300: after determining that a user has logged into a website system, the process obtains a corresponding characteristics attribute set according to operations of the user's browsing behavior, and, according to the characteristics attribute set, selects a matching rule in the preset rules database. The rule is used to select an alternative advertisement complying with the user's characteristics attribute.

For example, with regards to a visitation by the user U₁ (male; interested in digital products; median and above income; recently purchased a touch-screen cell phone; a visiting time period is weekend's morning; often visits advertisement positions of news category), the process, through a function H_{similarity}(U₁,Fᵢ), computes all rules in the rules database 10 that have degree values similar to those of U₁, ranks the similar degree values in a reverse order, and selects rules at Top X positions according to a set threshold. These rules are the rules having a characteristics attribute that is the same as or similar to that of the user U₁.

$${H}_{similarity} ( x , y ) = {\prod }_{i} {\sum }_{j} sim ( Norm ( {x}_{i}^{j} ) , Norm ( {y}_{i}^{j} ) ) ,$$

wherein, x, yεF, F=(Fₐ,F_{b},F_{c},F_{d},Fₑ,F_{f}), iε[a, f], F₀˜F_{f} are preset sets describing various advertisement attributes in the rules database. F₀˜F_{f} is used to construct Fᵢ, and j is a component included in Fᵢ. Certainly, the above F=(Fₐ,F_{b},F_{c},F_{d},Fₑ,F_{f}) is only an example. In real application, based on real application environment, the apparatus can increase more defined vector set, such as F=(F₁,F₂, . . . , Fₙ), wherein Fₐ,F_{b},F_{c},F_{d},Fₑ,F_{f} are six of them. The above formula

$${H}_{similarity} ( x , y ) = {\prod }_{i} {\sum }_{j} sim ( Norm ( {x}_{i}^{j} ) , Norm ( {y}_{i}^{j} ) )$$

is also applicable, wherein x, yεF, F=(F₁,F₂, . . . , Fₙ), iε[1, n], F₀˜Fₙ are preset sets describing various advertisement attributes in the rules database. F₀˜Fₙ is used to construct Fᵢ, j is a component included in Fᵢ.

By using the search function H_{similarity}, with respect to the user U₁, the process selects the rule R1: (male user; interested in digital products; median and above income; recently purchased touch-screen cell phone; often visits advertisement positions of news category; a clicked advertisement is a MP3; a price of purchased advertised product <$2000; a time period for advertisement place is weekends; a credit score of the merchandiser who places the advertisement is higher than 20; a presentation form of the advertisement is flash; an exact matching placement by selection of keyword; $0.2<an average click-through bidding price <$0.4).

In an actual situation, the finally selected rule(s) can be one or multiple rules. In one embodiment, the rules matching, or otherwise corresponding to, the characteristics attribute set of the logged-in user are presupposed to be R4, R5, and R6.

Action 310: the process selects a corresponding alternative advertisement based on the selected rule.

For example, assuming the rules matching the characteristics attribute set of the user are R4, R5, and R6, then the process uses the user ID and a keyword extracted from the selected rule as parameters, and transmits them to an advertisement search engine. The advertisement search engine searches corresponding alternative advertisements according to the parameters. In one embodiment, the rules matching the characteristics attribute set of the user are presupposed to be R4, R5, and R6, and the selected corresponding alternative advertisements are presupposed to be the advertisement A, the advertisement B, and the advertisement C, respectively.

Action 320: the process conducts a probability competition of the obtained alternative advertisements.

In one embodiment, the following described method is used to conduct probability competition of the alternative advertisements.

The selected advertisements according to rules R4, R5, and R6 are represented as Aᵢ^{j}, wherein i represents a corresponding rule, and j represents a number of the obtained alternative advertisements. In this embodiment, i may be the values 4, 5, and 6. All of the selected advertisements can be expressed as follows:

$$\begin{matrix}{R}_{4} \\ {R}_{5} \\ {R}_{6}\end{matrix} = ( \begin{matrix}{A}_{4}^{1} & & {A}_{4}^{j} \\ {A}_{5}^{1} & … & {A}_{5}^{j} \\ {A}_{6}^{1} & & {A}_{6}^{j}\end{matrix} )$$

Procedures of the probability competition are described below.

The apparatus ranks selected rule Ri by a reversing order according to the computed probability competition score Hᵣₑₛᵤₗₜ. A function Hᵣₑₛᵤₗₜ(x,y)=e^{βS}×H_{similarity}(x,y) is accepted, wherein β is a preset effect inflation factor, which is initially set at 1. An administrator can optimize it according to a test effect of a selected β parameter. The parameter S is an effect score of a rule corresponding to y, x, yεF_{abcd}, F_{abcd}=(Fₐ,F_{b},F_{c},F_{d}). The parameter x represents a connection vector of an advertisement position vector F_{ab} and a user characteristics vector F_{cd} corresponding to a specific visitation of the user, and also attributes to F_{abcd}.

The process selects Top X (top X ranking results) from the ranked Ri, and determines a corresponding alternative advertisement from the selected Top X. In one example, if X is presupposed to be 2, then the finally selected rules are R4 and R5, and corresponding alternative advertisements are advertisement A and advertisement B represented as A₄^{j},A₅^{j}. Such set of selected advertisements is referred to as Ad.

Finally, the process conducts random sampling for the set Ad. A number of sampling is Y (according to the parameter setting of the system, Y is presupposed to be 1), then the finally obtained probability competition result can be advertisement A, or advertisement B.

Action 330: the process places and presents the finally selected advertisement.

Action 340: the process monitors operations of the user with respect to the finally selected advertisement, and updates the preset rules database 10 according to collected advertisement placement effects data.

In the above action 340, the process, after placing and presenting the finally selected advertisement, further collects and records logs generated by the placement in action 350. Main contents of the logs include, but not are limited to: a user ID, a visitation time, a clicked advertisement position, a browed advertisement position, and a collected product, and so on.

After a period of time from the placement time, the process calculates placement effects of the above advertisements. Specifically, the process calculates the advertisement placement effect data (including an effect score S and a support degree N), and updates rules stored in the preset rules database 10 according to the calculated advertisement placement effect data. In one embodiment, there are two operations when updating the rules database 10: firstly, a corresponding new rule according to the advertisement placement effect data is extracted and added to the rules database 10; secondly, an existing rule in the rules database 10 is optimized according to the advertisement placement effect data.

The extraction means that the process converts a frequently occurring (or probability being above a threshold) advertisement effect statistics index vector Fₛₜₐₜ into a rule.

For example, a user U in a certain time period T visits a specific webpage W. There is an advertisement position P on the webpage and the advertisement position P presents the advertisement A to the user U. After the user U views the advertisement A, the user U clicks a link on the advertisement A, views a product details page P promoted by the advertisement A, and purchases a product I on the product details page P, and bookmarks a product J. Such series of operations of the user U are recorded by the system as (U, T, W, P, A, I, J), details of which can be found with reference to the above-discussed set C and set D.

Afterwards, the process analyzes the recorded series of operation of the user, and correspondingly stores as a characteristics attribute set of the user. This procedure includes converting T to a corresponding placement time period Ti, a placement season Ts, a determination whether there is an important holiday, and so on.

The process then converts W and P to an advertisement position characteristics data set required by the rules database 10 by advertisement position data in customer relationship management (CRM) and advertisement position textual data in the existing advertisement search engine. The above-discussed set A includes the details.

Finally, the process, through the advertisement data in the advertisement CRM system and an advertising client's promoted product system, obtains detailed attributes of A and I, and consolidates them into the characteristics data of the placed advertisement, the details of which can be found with reference to the above-discussed set F.

Thus, the series operations of the user (U, T, W, P, A, I, J) are converted into the above-referenced advertisement effect statistics index vector Fₛₜₐₜ.

According to the formula

$$S = {\sum }_{i = 1}^{8} {w}_{i} \times Norm ( {F}_{g}^{i} ) ,$$

the process calculates the effect score S_{new} and the support degree N_{new} of the advertisement effect statistics index vector Fₛₜₐₜ. When S_{new}>a set threshold, and N_{new}>a set threshold, if Fₛₜₐₜ does not exist in the rules database 10, Fₛₜₐₜ is added to the rules database 10 as the extracted new rule. Thus the extraction of a new rule is completed.

If the Fₛₜₐₜ already exists in the rules database 10, then an originally stored effect score of the Fₛₜₐₜ is recorded as S_{old}, and an originally stored support degree of the Fₛₜₐₜ is recorded as N_{old}. Then a consolidated effect score is calculated by the following formula:

S_{consolidation}=α×S_{old}(1−α)×S_{new}

N_{consolidation}=β×N_{old}+(1−β)×N_{new}

Based on the calculation result, if S_{consolidation}>a set threshold, and N_{consolidation}>a set threshold, then the S_{old} in the originally stored rule Fₛₜₐₜ is updated by S_{consolidation}, the N_{old} in the originally stored rule Fₛₜₐₜ is updated by N_{consolidation}; if S_{consolidation}<a set threshold, or N_{consolidation}<a set threshold, then the corresponding rule Fₛₜₐₜ is deleted from the rules database 10. Thus, the optimization of the current rules is completed.

A calculation function of the support degree N is as follows:

$$Support ( x ) \text{:} Support ( x ) = \frac{\vert x \vert}{\vert Set F \vert} , x ∈ {F}_{stat} ,$$

wherein in a certain time period, a recorded Fₛₜₐₜ vector set is referred to as SetF, xεFₛₜₐₜ.

On the other hand, in the above embodiment, after action 300, preferably, the process can also make genetic variance of a select rule to add new rules in the rules database 10. The process can make genetic variance to all of the selected rules, or randomly sample the selected rules and only make genetic variance to the selected rule.

In one embodiment, the acceptable genetic variance methods include, but are not limited to: using a genetic algorithm to make cross variance of the rule selected by action 300. The details are described below.

Assuming the rules for genetic variance are R4=(Fₐ,F_{b},F_{c},F_{d},Fₑ,F_{f},F_{g}), and R5=(Fₐ,F_{b},F_{c},F_{d},Fₑ,F_{f},F_{g})′, then the process firstly encodes the rules R4 and R5. A natural encoding method may be utilized.

The process then selects a variance point of the rules R4 and R5. To avoid many useless progenies from the variance, the variance point may be selected as a location between F_{d} and Fₑ. The detailed position can be shown as a double-line as follows:
(Fₐ,F_{b},F_{c},F_{d}∥Fₑ,F_{g},F_{g}).

Then R4=(Fₐ,F_{b},F_{c},F_{d},Fₑ,F_{f},F_{g}) can be split according to the location of the variance point as:
(Fₐ,F_{b},F_{c},F_{d}) and (Fₑ,F_{f},F_{g}).

Then the process cross-interconnects the split vectors:
(Fₐ,F_{b},F_{c},F_{d}) and (Fₑ,F_{f},F_{g}) are connected to obtain (Fₐ,F_{b},F_{c},F_{d},(Fₑ,F_{f},F_{g})′), and
(Fₐ,F_{b},F_{c}, F_{d})′ and (Fₑ,F_{f},F_{g})′ are connected to obtain ((Fₐ,F_{b},F_{c},F_{d})′,Fₑ,F_{f},F_{g}).

Thus, new rules (Fₐ,F_{b},F_{c},F_{d},(Fₑ,F_{f},F_{g})′) and ((Fₐ,F_{b},F_{c},F_{d})′,Fₑ,F_{f},F_{g}) are obtained after genetic variance.

In the above embodiment, the process can make genetic variance to an existing rule by granting a proper probability “variance” to the advertisement placement strategy at the same time when selecting top best optimization rules based on historical effects. These variances guarantee an “evolution” of the rules database 10, can find and discover new rules, and are beneficial to the placement mode of promotion advertisements.

As a whole, the embodiments of the present disclosure introduce a concept of the rules database 10 to accumulate good placement experiences. The proposed technique addresses various effects arising from prior advertisement placements, categorizes them according to various factors associated with placement, conducts statistics of preferred advertisement placements effects in each category, summarizes some preferred placement matching rules in each category of placement, and conducts genetic evolution to accumulate experiences to guide updates of the rules database 10 in the future. Thus, the advertisement placement based on the rules database 10 is easy to implement, and can better achieve global optimization. On the other hand, in addition to guidance of advertisement placement online, the rules database 10 also provides summarization of experiences and guide development and creation of business offline.

The establishment and evolution of the rules database 10 directly depend on the advertisement placement effects. Changes of advertisement placement effects will be timely reflected in various stored rules for guidance of selection of advertisements through the rules database 10. The selection of advertisements depends on the placement effects. Consequently, there occurs a large placement cycle: placing advertisement-tracking placement effects-updating rules-re-placing advertisement. Thus the purpose and means are combined. In other words, the update and evolution of the rules database 10 are real-time and based on advertisement effects, thereby automatically optimizing various rules in real time. Advantages of the proposed technique also include minimal implementation cost, short period, and quick optimization speed. There is no need to blindly reduce advertisement placement volumes. Rather, the advertisement placements are based on actual needs of the user and are placed purposefully. Based on the guaranteed advertisement effects, the technique described herein reduces the transmitted data volume when placing the advertisements, improves the data transmission speed of the system, and improves service quality of the website.

A person of ordinary skill in the art can make various changes and modifications of the present disclosure without deviating from the spirit and scope of the present disclosure. Therefore, provided that such changes and modifications of the present disclosure are within the coverage of the claims and spirit of the present disclosure or its equivalents, the present disclosure also covers such changes and modifications.

What is claimed is:

1. A method for increasing website data transmission speed, the method comprising:
obtaining a characteristics attribute set corresponding to a browsing behavior of a user;
obtaining at least one rule corresponding to the characteristics attribute set from a rules database;
selecting at least one advertisement corresponding to a scenario stipulated by the at least one rule;
placing the at least one advertisement to be presented to the user; and
monitoring operations of the user with respect to the placed at least one advertisement.

2. The method as recited in claim 1, further comprising:
collecting parameters with respect to the at least one advertisement;
storing the visitation information in website logs; and
extracting a characteristics attribute from the website logs for the user.

3. The method as recited in claim 2, further comprising:
converting the collected parameters to a corresponding rule to update the rules database.

4. The method as recited in claim 2, wherein the collected parameters comprise a user click rate, a browsing volume after arrival of a target webpage, a volume of registration, and a volume of bookmark.

5. The method as recited in claim 1, further comprising:
calculating a respective similarity degree between each of a plurality of rules in the rules database and the characteristics attribute set;
ranking the plurality of rules from high to low according to the calculated respective similarity degrees; and
selecting a number of the ranked rules, among the ranked rules, starting from a rule with a highest similarity degree.

6. The method as recited in claim 5, wherein:
calculating the respective similarity degree comprises using a formula
$${H}_{similarity} ( x , y ) = {\prod }_{i} {\sum }_{j} sim ( Norm ( {x}_{i}^{j} ) , Norm ( {y}_{i}^{j} ) )$$
to calculate the respective similarity degree, wherein:
x, yεF, F=(F₁,F₂, . . . , Fₙ);
iε[1, n];
F₀˜Fₙ represent preset sets describing various advertisement attributes in the rules database;
F₀˜Fₙ are used to construct Fᵢ; and
j represents a component included in Fᵢ.

7. The method as recited in claim 6, wherein selecting at least one advertisement corresponding to a scenario stipulated by the at least one rule comprises:
obtaining, by an advertisement search engine, one or more corresponding alternative advertisements;
using a formula Hᵣₑₛᵤₗₜ(x,y)=e^{βS}×H_{similarity}(x,y), to calculate a probability competition score of the at least one rule;
ranking the at least one rule according to the probability competition score from high to low;
selecting a number of rules, among the at least one rule, starting from a rule having a highest probability competition score; and
determining at least one alternative advertisement corresponding to the number of selected rules as a final advertisement to be placed.

8. The method as recited in claim 2, further comprising:
extracting a newly generated rule from the collected parameters based on operations of the user with respect to the placed at least one advertisement;
calculating an effect score S_{new} and a support degree N_{new} of the newly generated rule;
in an event that the newly generated rule does not exist in the rules database, and each of the S_{new} and N_{new} is higher than a respective threshold, adding the newly generated rule to the rules database; and
in an event that the newly generated rule already exists in the rules database, calculating a consolidated effect score S_{consolidation} and a consolidated support degree N_{consolidation} of the newly generated rule and an originally stored rule in the rules database,
in an event that each of the S_{consolidation} and N_{consolidation} is higher than a respective threshold, storing the S_{consolidation} and N_{consolidation} into into the rules database; and
in an event that either of the S_{consolidation} and N_{consolidation} is lower than the respective threshold, deleting the newly generated rule from the rules database.

9. The method as recited in claim 8, further comprising:
using a formula
$$S = {\sum }_{i = 1}^{8} {w}_{i} \times Norm ( {F}_{g}^{i} )$$
to calculate the effect score S_{new} of the newly generated rule and using a formula
$$Support ( x ) = \frac{\vert x \vert}{\vert Set F \vert}$$
to calculate the support degree N_{new} of the newly generated rule, wherein:
$${\sum }_{i = 1}^{8} {w}_{i} = 1 ,$$
wᵢ represents a preset expert weight factor;
Norm(F_{g}ⁱ)=100×(F_{g}ⁱ/ F̅_̅{̅g̅}̅ⁱ̅), a normalized function; and
Fₛₜₐₜ represents the newly generated rule, xεFₛₜₐₜ, SetF represents a recorded Fₛₜₐₜ vector set in a certain time period.

10. The method as recited in claim 8, further comprising:
using formulas
S_{consolidation}=α×S_{old}+(1−α)×S_{new}
N_{consolidation}=β×N_{old}+(1−β)×N_{new}
to calculate the consolidated effect score S_{consolidation} and the consolidated support degree N_{consolidation} of the newly generated rule and the originally stored rule in the rules database, wherein:
α and β are preset inflation factors; and
S_{old} and N_{old} are the effect score and the support degree of the originally stored rule.

11. The method as recited in claim 1, further comprising:
according to the characteristics attribute set, obtaining at least two rules corresponding to the characteristics attribute set from the rules database; and
conducting a cross variance of the at least two rules according to a genetic variance algorithm.

12. A system for increasing website data transmission speed, the system comprising:
a rules database that stores a plurality of rules to search advertisements; and
an advertisement placement administration apparatus communicatively coupled to the rules database, the advertisement placement administration apparatus configured to perform:
obtaining a characteristics attribute set corresponding to a browsing behavior of a user;
obtaining at least one rule corresponding to the characteristics attribute set from a rules database;
selecting at least one advertisement corresponding to a scenario stipulated by the at least one rule;
placing the at least one advertisement to be presented to the user; and
monitoring operations of the user with respect to the placed at least one advertisement.

13. The system as recited in claim 12, wherein the advertisement placement administration apparatus is further configured to perform:
collecting parameters with respect to the at least one advertisement;
storing the visitation information in website logs; and
extracting a characteristics attribute from the website logs for the user.

14. The system as recited in claim 13, wherein the advertisement placement administration apparatus is further configured to perform:
converting the collected parameters to a corresponding rule to update the rules database.

15. The system as recited in claim 12, wherein the advertisement placement administration apparatus is further configured to perform:
calculating a respective similarity degree between each of a plurality of rules in the rules database and the characteristics attribute set;
ranking the plurality of rules from high to low according to the calculated respective similarity degrees; and
selecting a number of the ranked rules, among the ranked rules, starting from a rule with a highest similarity degree.

16. The system as recited in claim 13, wherein the collected parameters comprise a user click rate, a browsing volume after arrival of a target webpage, a volume of registration, and a volume of bookmark.

17. An apparatus for increasing website data transmission speed, the apparatus comprising:
an obtaining unit that obtains a characteristics attribute set corresponding to a browsing behavior of a user, and, according to the characteristics attribute set, obtains at least one rule corresponding to the characteristics attribute set from a rules database;
a first processing unit that selects at least one advertisement corresponding to a scenario stipulated by the at least one rule, and places the at least one advertisement to be presented to the user; and
a second processing unit that monitors operations of the user with respect to the placed at least one advertisement, and converts collected parameters to a corresponding rule to update the rules database.
